(19) United States
(12) Patent Application Publication
(10) Pub. No.: US 2022/0152870 A1
(43) Pub. Date: May 19, 2022

(54) A CONTAINER

(71) Applicant: CRH Nederland B.V., Amsterdam (NL)

(72) Inventors: Diego A. Santamaria Razo, Amsterdam (NL); José Amir González Calderón, Celaya Guanajuato (MX)

(73) Assignee: CRH Nederland B.V., Amsterdam (NL)

(21) Appl. No.: 17/601,028

(22) PCT Filed: Apr. 3, 2020
(86) PCT No.: PCT/EP2020/059496

§ 371 Date: Oct. 1, 2021

(30) Foreign Application Priority Data
Apr. 4, 2019 (EP) 19167445.6

(51) Int. Cl. B28C 5/02; B65D 75/58; B01F 23/50; B01F 35/71; B01F 35/513; C04B 28/02

(52) U.S. Cl. CPC B28C 5/023; B65D 75/5872; B01F 23/511; B01F 35/7171; B01F 2101/28; B01F 35/513; B01F 23/56; C04B 28/02; B01F 35/71805

(57) ABSTRACT

The invention relates to a container, wherein the container comprises a wall and a valve, wherein the wall defines an interior cavity, wherein the cavity has an adjustable volume, wherein the cavity contains a composition, wherein the composition comprises a nanomaterial, and wherein the volume of the composition is less than or equal to about 50 vol % of the maximum volume of the cavity.

The present invention relates to a container for transporting nanomaterials, a process of making a dilute composition comprising nanomaterials and the use of nanomaterials in the production of concrete or mortar.

It is known to use nanomaterials in compositions. There are many difficulties in handling nanomaterials such as the health and safety problems associated with handling such fine powders. In particular, it is undesirable for nanomaterials to be inhaled. Nanomaterials can be provided in a colloidal suspension, typically at a concentration of up to about 5 wt % nanomaterial, such as up to about 1 wt % nanomaterial. Such suspensions are costly to transport due to the weight of the suspension, compared to the weight of the desired nanomaterials. This results in a high carbon footprint for the transport of the nanomaterials which is detrimental to the environment.

Further, such suspensions have a limited shelf life because the nanomaterials settle over time. This means that a homogeneous colloidal suspension of nanomaterials is difficult to make and store. The problem of settling is exasperated when such suspensions are transported, such as by a truck, as the movement, such as shaking, increases the rate of settling of the nanomaterials. This means that in practice, the end user cannot be certain that the suspension they wish to use has the desired distribution of nanomaterials. This causes issues during the use of nanomaterials in a manufacturing process as the amount of nanomaterial used cannot readily be determined. Further, from an environmental point of view it is highly undesirable that the colloidal suspensions of nanomaterials have a limited shelf life.

There is a need for an efficient and safe way to transport nanomaterials. There is a need for a way to transport nanomaterials which reduces the cost and environmental impact of transporting them. There is a need to reduce the carbon footprint of transporting nanomaterials. There is a need for a method of producing a substantially homogeneous colloidal suspension of nanomaterials. There is a need for a simple and safe way to make a colloidal suspension of nanomaterials.

It is, therefore, an object of the present invention to seek to alleviate the above identified problems.

### SUMMARY OF THE INVENTION

According to a first aspect of the present invention, there is provided a container, wherein the container comprises a wall and a valve,

wherein the wall defines an interior cavity,

wherein the cavity has an adjustable volume,

wherein the cavity contains a composition,

wherein the composition comprises a nanomaterial, and

wherein the volume of the composition is less than or equal to about 50 vol % of the

maximum volume of the cavity.

According to a second aspect of the present invention, there is provided a process for making a diluted composition, comprising;
(i) providing a container as described in the first aspect of the invention,
(ii) providing a solvent supply;
(iii) adding the solvent into the cavity of the container through the valve, and
(iv) dispersing the nanomaterial in the solvent to form a diluted composition.

According to a third aspect of the invention, there is provided a use of a container according to the first aspect of the invention in a process of producing concrete or mortar.

According to a fourth aspect of the invention, there is provided a process for the production of concrete or mortar, comprising:
(a) providing a cement;
(b) providing an aggregate;
(c) providing a nanomaterial, wherein providing the nanomaterial comprises;
   (i) providing a container as described in the first aspect of the invention;
   (ii) providing a solvent;
   (iii) adding the solvent into the cavity of the container through the valve, and
   (iv) dispersing the nanomaterial in the solvent to form a diluted composition;
(d) removing the diluted composition from the container, and
(e) mixing the cement, the aggregate and the diluted composition to produce concrete or mortar.

According to a fifth aspect of the invention, there is provided a system for use in the production of a colloidal suspension of a nanomaterial, comprising;
(A) a container as described in the first aspect of the invention;
(B) a solvent supply;
(C) a tube connecting the valve of the container to the solvent supply, and
(D) a mixer.

### BRIEF DESCRIPTION OF THE DRAWINGS

FIG. 1 shows a top view of a container.

FIG. 2 shows a side view of a container.

FIG. 3 shows a side view of a container.

FIG. 4 shows a filled container and a tube.

FIG. 5 shows a container being filled.

FIG. 6 shows a side view of a container with an inlet valve and an outlet valve.

FIG. 7 shows a flow chart.

### DETAILED DESCRIPTION

The present invention relates to a container, wherein the container comprises a wall and a valve,

wherein the wall defines an interior cavity,

wherein the cavity has an adjustable volume,

wherein the cavity contains a composition,

wherein the composition comprises a nanomaterial, and

wherein the volume of the composition is less than or equal to about 50 vol % of the maximum volume of the cavity.

It is an advantage of the container of the invention that it can be used to safely transport a composition comprising a nanomaterial to a desired location. The composition can then be diluted to give a dilute composition. This has the advantage that it is not necessary to transport a heavy composition, with only a small amount of nanomaterial in it. Instead, the nanomaterial is safely contained in the container, without any risk of a person inhaling the nanomaterial. The composition can then be diluted when it is needed. This can either occur at the location that the diluted composition will be used, or at an alternative location. This gives the flexibility to make the diluted composition where, and when it is needed. This vastly reduces the weight of the composition which is transported and results in a lower carbon footprint. Further, the diluted composition can be substantially homogenous as it can be made where, and when it is needed. This helps with logistics as the container may be provided in advance of when it is needed to be used and the composition diluted when needed. Further, since the container is not full, it takes up less storage space than a container that contains a diluted composition. This also means that more containers can be transported, for example in a single truck, which further reduces the carbon foot print of the process. Diluting the composition makes it easier to mix the nanomaterial with other components of a process, such as a process of making concrete or mortar. Increasing the volume of the composition helps an even distribution of nanomaterials to be distributed through a mixture, such as in the process of making concrete or mortar.

Preferably the volume of the composition is in the range of about 0.001 vol % to about 50 vol % of the maximum volume of the cavity, preferably in the range of about 0.001 vol to about 30 vol %, preferably in the range of about 0.001 vol % to about 25 vol %, preferably in the range of about 0.001 vol % to about 20 vol %, preferably in the range of about 0.001 vol % to about 10 vol %, preferably in the range of about 0.001 vol % to about 5 vol %, preferably in the range of about 0.001 vol % to about 1 vol %, preferably in the range of about 0.001 vol % to about 0.5 vol %, preferably in the range of about 0.01 vol % to about 0.1 vol %. It is an advantage of the invention that smaller volumes of the composition can be transported for subsequent dilution. This saves energy as the weight of the composition is vastly reduced compared to the diluted composition. It is particularly preferred that the volume of the composition is in the range of about 0.001 vol % to about 1 vol % of the maximum volume of the cavity, preferably in the range of about 0.001 vol to about 0.5 vol %, preferably in the range of about 0.01 vol % to about 0.1 vol % as this greatly reduces the amount, and thus the volume and weight of the composition that is to be transported.

The maximum volume of the cavity is the maximum volume of fluid that the cavity can hold. The maximum volume can be measured by measuring the volume of water that the cavity can hold at a temperature of 20 20 C., when the water is supplied at a pressure of 3 bar.

Preferably, “volume of the cavity” means “fillable volume of the cavity”.

Preferably, “maximum volume” means “maximum fillable volume” of the cavity.

Preferably, the maximum volume of the cavity means the capacity of the cavity.

Preferably the volume of the composition is at least about 0.001 vol % of the maximum volume of the cavity, preferably at least about 0.01 vol %, preferably at least about 0.1 vol %, preferably at least about 5 vol %, preferably at least about 10 vol %. Such volumes are suitable to transport a desired amount of the composition.

Preferably the volume of the composition is less than about 50 vol % of the maximum volume of the cavity, preferably less than about 40 vol %, preferably less than about 30 vol %, preferably less than about 25 vol %, preferably less than about 20 vol %, preferably less than about 10 vol %, preferably less than about 5 vol %, preferably less than about 1 vol %, preferably less than about 0.5 vol %, preferably less than about 0.1 vol %, preferably less than about 0.01 vol %. It is an advantage of the invention that smaller volumes of the composition can be transported for subsequent dilution. This saves energy as the weight of the composition is vastly reduced compared to the desired diluted composition.

Preferably the maximum volume of the cavity is in the range of about 0.1 L to about 30 L, preferably in the range of about 0.5 L to about 20 L, preferably in the range of about 0.5 L to about 15 L, preferably in the range of about 0.5 L to about 10 L, preferably in the range of about 1 L to about 5 L. Such volumes allow sufficient dilution of the composition, whilst allowing the container to be of a size that can be moved.

Preferably, the wall of the container is flexible. Preferably flexible means that the shape of the wall can be changed by applying pressure, such as a pressure of 0.1 bar. Preferably the change of shape is not permanent, such that when there is a change in the amount of pressure applied, or a change in the direction of the pressure, the shape of the wall of the container may change. This allows the volume of the cavity of the container to be easily adjusted by adding or removing fluid, such as liquid or gas from the container via the valve. The flexible wall can change shape depending on the amount of fluid in the cavity. This allows the volume of the cavity of the container to be easily adjusted. It is particularly advantageous to reduce the volume of the cavity when it only contains the composition in order to reduce the overall size of the container. This allows the container to take up less space. The volume of the cavity can be increased when the composition is diluted by adding a fluid, preferably by adding a solvent, preferably a polar solvent, preferably water or ethanol, preferably water.

Preferably the volume of the cavity is adjusted/adjustable by moving the wall. This allows the volume of the cavity of the container to be easily adjusted. It is particularly advantageous to reduce the volume of the cavity when it only contains the composition in order to reduce the size of the container. This allows the container to take up less space. The volume of the cavity can be increased when the composition is diluted.

Preferably, the volume of the cavity is adjusted/adjustable by compressing the container.

Preferably, the volume of the cavity is adjusted/adjustable by squashing the container.

Preferably the volume of the cavity is adjusted by adding or removing fluid from the cavity via the valve. This provides an efficient way of adjusting the volume of the cavity.

Preferably, the wall of the container comprises a polymer, silicon, foil or a combination of two or more thereof, preferably polyethylene, polypropylene, polyvinyl chloride, polyethylene terephthalate, aluminium foil or a combination of two or more thereof. Such materials have the advantage of being flexible materials that give the wall freedom of movement between a reduced cavity volume and a maximum cavity volume, and yet still be strong to safely retain their contents under the forces of transport.

Preferably the wall of the container comprises laminate layers. Preferably the wall of the container comprises aluminium and polymer layers. Such a structure helps maintain the shape of the wall and helps prevent degradation due to sunlight.

Preferably the thickness of the wall is in the range of about 10 μm to about 5 mm, preferably in the range of about 50 μm to about 2 mm. Such thickness allows the wall to be flexible and have sufficient resilience.

Preferably the cavity comprises substantially only the composition, and substantially no gas, such as air. This reduces the volume of the cavity, and preferably the size of the container to a minimum size and reduces the amount of space that is needed to transport and store the container. Further, the absence of substantially any gas in the cavity means that the composition does not substantially react with the gas. Any gas present in the cavity may be removed by expelling the gas through the valve, such as by applying pressure to the wall of the container, or by using a pump.

Preferably about 20 vol % of the maximum volume of the cavity comprises gas, such as air, preferably about 0.1 vol % to about 15 vol %, preferably about 1 vol % to about 10 vol %, preferably about 1 vol % to 5 vol %. This means that it is not necessary to remove all the gas and is efficient from a manufacturing point of view.

Preferably, the wall of the container is stretchable, for example such that the wall balloons out when a fluid is introduced into the cavity and the wall contracts when fluid is removed from the cavity. This has the advantage of being easy to move the walls of the container and to control the shape of the container.

Preferably the wall of the container is not substantially stretchable. This reduces the possibility of the end user overfilling the container and putting it under too much pressure which may lead to a failure in the wall of the container or the valve.

Preferably the size of the container varies with the volume of the cavity. This allows the overall size of the container to be reduced when the cavity is not filled to capacity.

Preferably the container is a sealed container. This prevents the composition from leaking out of the container.

Preferably the container is a pouch, preferably a sealed pouch. A pouch is a suitable container for the present invention as it combines the ability to hold fluid, with the ability to change the shape of the wall of the container when pressure is applied, such as when fluid is added to or removed from the pouch.

Preferably, the first aspect of the present invention relates to a pouch comprising a wall and a valve,

wherein the wall defines an interior cavity,

wherein the cavity contains a composition,

wherein the composition comprises a nanomaterial, and

wherein the volume of the composition is less than or equal to about 50 vol % of the maximum fillable volume of the cavity.

Preferably, the first aspect of the present invention relates to a sealed container, wherein the container comprises a flexible wall and a valve,

wherein the wall defines an interior cavity,

wherein the cavity has an adjustable volume,

wherein the cavity contains a composition,

wherein the composition comprises a nanomaterial,

wherein the volume of the composition is less than or equal to about 1 vol % of the maximum volume of the cavity, and

wherein the maximum volume of the cavity is about 0.5 L to about 10 L.

Preferably the valve allows access to the cavity in a first valve position and prevents access to the cavity in a second valve position. This allows fluid to be moved in and out of the cavity as required and allows the composition to be contained in the cavity when required.

Preferably, the valve is a two-way valve. A two-way valve allows ease of use for all personnel involved in the use of the product as there is only one valve to connect to a solvent supply, or to use to remove the diluted composition.

Preferably the container comprises an inlet valve and an outlet valve. This allows fluid to be introduced into the cavity via the inlet valve and it allows fluid to exit the container. Preferably the inlet valve is a one-way valve. Preferably the outlet valve is a one-way valve. This improves the resilience of the valves as fluid only flows in one direction.

Preferably the container is reusable. This is environmentally friendly as the container can be emptied after use and returned to have another composition added. This reduces the waste and makes the container cost effective. Preferably the container is reused/reusable with the same type of nanomaterial to reduce the need for cleaning in between uses. This is because any residual nanomaterial left in the emptied container will be such a small amount, that it will not substantially change the concentration of the nanomaterial in the new composition added. Preferably the container is washed before reuse to minimise the amount of residual nanomaterial present.

Preferably the container is shaped such that the volume of the cavity is adjusted by the wall of the cavity moving in substantially one direction, such as to increase the height of the container. This has the advantage of allowing the volume of the cavity to be controllably increased and decreased. This allows efficient storage of more than one container, such as by stacking an array of containers on top of each other.

Preferably the container is shaped such that the volume of the cavity is adjusted/adjustable by compressing the container in substantially one direction, such as to decrease the height of the container.

Preferably the shape of the container, when the cavity is at a maximum volume, is substantially a cuboid. A cuboid has six rectangular faces at right angles to each other. This has the advantage of the container being easy to manufacture. Further it maximises the use of the storage or transport space.

Preferably the container comprises curved edges. This facilitates mixing of the composition with a solvent.

Preferably the length, width and height of the container, when the cavity is at a maximum volume, are each independently in the range of about 5 cm to about 50 cm, preferably in the range of about 10 cm to about 50 cm, preferably in the range of about 10 cm to about 30 cm.

A nanomaterial is a material in which a single unit has a size in at least one dimension in the range of about 1 nm to about 1000 nm, preferably in the range of about 1 nm to about 100 nm.

Preferably the nanomaterial comprises nanoparticles, nanonetworks, nanotubes, nanosheets or a combination of two or more thereof.

Preferably the nanomaterial comprises nanoparticles. Such nanoparticles typically have a size in all three dimensions in the range of about 1 nm to about 1000 nm, preferably in the range of about 1 nm to about 100 nm. Preferably the nanoparticles comprise carbon black nanoparticles, zirconia nanoparticles, titanium oxide nanoparticles, nano-graphite, carbon nanoparticles, metal nanoparticles (such as gold, silver, copper, iron, titanium, platinum, nickel, or alloys thereof), or metal oxide nanoparticles (such as gold, silver, copper, iron, titanium, platinum or nickel), or a combination of two or more thereof.

Preferably the nanomaterial comprises nanonetworks or nanotubes. Such nanomaterials typically have a size in a first dimension in the range of about 1 nm to about 1000 nm, preferably about 1 nm to about 100 nm, and a size in a second dimension in the range of about 1 μm to about 1 mm, preferably in the range of about 5 μm to about 0.5 mm. Preferably the nanonetwork or the nanotube has a size in a third dimension in the range of about 1 nm to about 1000 nm, preferably in the range of about 1 nm to about 100 nm. Preferably the nanonetwork comprises a silica nanonetwork. Preferably the nanotube comprises a carbon nanotube, preferably a single walled carbon nanotube (SWCNT).

Preferably the nanomaterial comprises a nanosheet. Such nanomaterials typically have a size in a first dimension in the range of about 1 to about 1000 nanometres, preferably in the range of about 1 nm to about 100 nm, and a size in a second dimension in the range of about 1 μm to about 1 mm, preferably in the range of about 5 μm to about 0.5 mm and a size in a third dimension in the range of about 1 μm to about 1 mm, preferably about 5 μm to about 0.5 mm. Preferably the nanosheet comprises graphene, a silicon nanosheet or a carbon nanosheet, preferably graphene.

Preferably the nanomaterial comprises silica nanoparticles, silica nano-networks, carbon nanotubes, single walled carbon nanotubes (SWCNT), graphene, a silicon nanosheet, a carbon nanosheet, carbon black nanoparticles, zirconia nanoparticles, titanium oxide nanoparticles, nano-graphite, carbon nanoparticles, metal nanoparticles (such as gold, silver, copper, iron, titanium, platinum, nickel or alloys thereof), or metal oxide nanoparticles (such as gold, silver, copper, iron, titanium, platinum, nickel), or a combination of two or more thereof. When used in the production of concrete or mortar, the nanomaterials are able to positively enhance its properties, including; compressive strength, tensile strength, ductility, bond strength, permeability, and/or shrinkage.

Preferably the nanomaterial comprises silica nanoparticles, silica nano-networks, carbon nanotubes, single walled carbon nanotubes (SWCNT), graphene, carbon black nanoparticles, zirconia nanoparticles, or titanium oxide nanoparticles, or a combination of two or more thereof, preferably silica nanoparticles, silica nano-networks, carbon nanotubes, or single walled carbon nanotubes (SWCNT), or a combination of two or more thereof.

Preferably the nanomaterial is present in the composition in the range of about 0.01 wt % to about 80 wt %, preferably in the range of about 1 wt % to about 50 wt %, preferably in the range of about 5 wt % to about 20 wt %.

Preferably the composition is a colloidal suspension or a powder. These are suitable ways to provide the composition in the container.

Preferably the composition further comprises a solvent, preferably a polar solvent, preferably water or ethanol, preferably water.

Preferably the composition further comprises a surface modifier. Preferably the surface modifier modifies the surface of the nanomaterial. An advantage of using a surface modifier is that it helps the nanomaterial disperse throughout the solvent when the composition is diluted.

Preferably the surface modifier is a surfactant, or the surface of the nanomaterial is functionalised with the surface modifier. These are suitable ways to help the nanomaterial disperse throughout the solvent when the composition is diluted.

Preferably the composition further comprises a surfactant, preferably an ionic surfactant, an anionic surfactant, a nonionic surfactant, a cationic surfactant, an amphoteric surfactant, or a silicone surfactant, or a combination of two or more thereof. Preferably the surfactant is selected from the list consisting of ethoxylated alcohols, amine derivatives, amide derivatives, sodium dodecyl benzene sulfonate, abietic acid, dimethyl ether of tetradecyl phosphonic acid, polyethoxylated octyl phenol, sorbitan monoester, glycerol diester, dodecyl betaine, N-dodecyl pyridinium chloride, sodium dodecyl sulphate, polyelectrolyte polystyrene sulfonate and combinations of two or more thereof. An advantage of using a surfactant is that it helps the nanomaterial disperse throughout the solvent when the composition is diluted.

Preferably the surface of the nanomaterial is functionalised. Preferably the nanomaterial is functionalised by adding an additional component to the surface of the nanomaterial by chemical bonding or by adsorption. An advantage of functionalizing the nanomaterial is that it helps the nanomaterial disperse throughout the solvent when the composition is diluted.

Preferably the surface of the nanomaterial is functionalised by a silane or a siloxane, preferably a linear silane, a cyclic silane, or a branched silane, linear siloxane, a cyclic siloxane, or a branched siloxane or a combination of two or more thereof. The silane may be a disilane or a trisilane and may be branched with functional groups, preferably halosilanes (such as chlorosilanes, iodosilanes or bromosilanes), sulphursilanes, methyl silanes, or phenol silanes, or a combination of two or more thereof.

Preferably the silane is Diethoxydimethylsilane, tetramethyl orthosilicate, Trim ethoxy(octadecyl)silane, aminopropyltriethoxysilane, Ethenylsilane, lodosilane, Silicic acid, 3-Chloropropyl trimethoxysilane, 3-Chloropropyl triethoxysilane, 3-Chloropropyl methyldimethoxysilane, 3-Chloropropyl methyldiethoxysilane, Bis-(3-triethoxysilylpropyl)-tetrasulfide, a blend of bis-(3-triethoxysilylpropyl)-tetrasulfide and carbon black, Bis-(3-triethoxysilylpropyl)-tetrasulfide in silica carrier, Bis-(3-triethoxysilylpropyl)-tetrasulfide in wax carrier, Bis-(3-triethoxysilylpropyl)-disulfide, a blend Bis-(3-triethoxysilylpropyl)-disulfide and carbon black, 3-Mercaptopropyltrimethoxysilane, 3-Mercaptopropyltriethoxysilane, 3-Aminopropyltriethoxysilane, 3-Aminopropyltrimethoxysilane, 3-Methacryloxypropyltrimethoxysilane, 3-Glycidoxypropyltrimethoxysilane, (Heptadecafluoro-1,1,2,2-tetradecyl)trimethoxysilane, 1 H,1 H,2H,2H-Perfluorodecyltrichlorosilane, Methyltrimethoxysilane, Vinyltriethoxysilane Vinyltrimethoxysilane, Vinyl tri-(2-methoxyethoxy)silane, Vinyltrimethoxysiloxane homopolymer, N-beta-(Aminoethyl)-3-aminopropylmethyldimethoxysilane, N-(Amino-ethyl)-amino-propyltrimethoxysilane, or 3-Aminopropylmethyldiethoxysilane, or a combination of two or more thereof. Such silanes are suitable for use in the present invention.

Preferably the siloxane is hexamethyldisiloxane, octamethyltrisiloxane, decamethyltetrasiloxane, dodecamethylpentasiloxane, tetradecamethylhexasiloxane, hexamethylcyclotrisiloxane, octamethylcyclotetrasiloxane, decamethylcyclopentasiloxane, dodecamethylcyclohexasiloxane or a combination of two or more thereof. Such siloxanes are suitable for use in the present invention.

The invention further relates to a process for making a diluted composition, comprising;
(i) providing a container as described herein,
(ii) providing a solvent supply;
(iii) adding the solvent into the cavity of the container through the valve, and
(iv) dispersing the nanomaterial in the solvent to form a diluted composition.

The process of the invention provides a safe and simple method of producing a diluted composition comprising a nanomaterial. The operator does not need to come into contact with the nanomaterial as it is contained within the container. The operator simply has to add the solvent into the cavity of the container thought the valve. The application of ultrasound ensures that the composition and the solvent are thoroughly mixed with the aim of producing a substantially homogeneous diluted composition. It is an advantage of the invention that the diluted composition can be produced when and where it is needed. This reduces transport costs, due to the reduced weight of the container, and allows the user to produce the composition as and when it is required. This reduces the likelihood of the nanomaterial settling out before it is finally used.

Preferably the solvent is a polar solvent, preferably water or ethanol, preferably water. Such solvents are suitable for producing a diluted composition. By using water as the solvent, that same water can then be used in the production of the concrete or mortar. This advantageously incorporates the nanomaterials into the production process, through an efficient and effective use of raw resources.

Preferably, the solvent supply is a water tap or water reservoir. A water tap, or water reservoir make for an ideal solvent supply. Production of concrete or mortar primarily takes place on site, allowing for the maximum time before it sets to apply and work it to the required positions. Therefore, in order to produce the concrete or mortar on site, a water tap, or water reservoir provides the most practical solution.

Preferably the solvent is mains water. This is readily available. It is particularly useful to use water, preferably mains water in the production of concrete or mortar as above.

Preferably, the solvent is added into the container through the valve using a tube. This allows efficient and accurate supply of the solvent used to dilute the composition, while maximising the safety of handling the composition for the user.

Preferably, the solvent is added into the container through the valve using a pump. This enables the fast, efficient and accurate supply of the solvent. It also enhances the safety of handling the composition as it reduces the need for human intervention.

Preferably, the diluted composition is a colloidal suspension of the nanomaterial. A colloidal suspension allows particular ease of using the nanomaterials in concrete or mortar production.

Preferably the nanomaterial is present in the dilute composition in the range of about 0.001 wt % to about 1 wt %, preferably in the range of about 0.001 wt % to about 0.1 wt %, preferably in the range of about 0.01 wt % to about 1 wt %. Such amounts of nanomaterial are suitable for use in further processes, such as in the production of concrete or mortar.

Preferably, the diluted composition is a substantially homogeneous colloidal suspension of the nanomaterial. A homogeneous colloidal suspension ensures an even distribution of nanomaterial throughout the concrete or mortar at the point of mixing in the production process. This then provides for the consistent production of an improved concrete or mortar material.

Preferably step iv comprises shaking the container at high frequency, to form a diluted composition. This is a suitable way to prepare a diluted composition.

Preferably step iv comprises applying ultrasound to the container to form a diluted composition. This is a particularly preferred method of thoroughly mixing the composition and the solvent to form a diluted composition.

Preferably step iv is about 30 seconds to about 30 minutes, preferably about 1 minute to about 20 minutes, preferably about 5 minutes to about 10 minutes.

Preferably the ultrasound is applied in step iv for about 30 seconds to about 30 minutes, preferably about 1 minute to about 20 minutes, preferably about 5 minutes to about 10 minutes. Such time periods are suitable for mixing the composition with the solvent.

Preferably the frequency of the ultrasound is in the range of about 1 kHz to about 30 kHz, preferably about 2 kHz to about 20kHz. Such frequencies are suitable for mixing the composition with the solvent.

Preferably the amplitude of the ultrasound is preferably in the range of about 10 μm to about 30 μm. Such amplitudes are suitable for dispersing the nanomaterial in the solvent.

Preferably the dilute composition is used in a further process, such as in a process of producing concrete or mortar.

Preferably the dilute composition is removed from the container via a tube connected to the valve. This is a simple and safe way to remove the diluted composition. Further the tube can be used to supply the diluted composition to a further process, such as in the production of concrete or mortar. Preferably the container is reused after the dilute composition has been removed.

Further, the present invention relates to a use of a container as described herein in a process of producing concrete or mortar.

The container of the invention has particular utility in the process of making concrete or mortar as it allows for the efficient transportation of a nanomaterial and subsequent use in a process of making concrete or mortar. There is a desire to reduce the carbon footprint of building processes, and in particular of the process of making concrete or mortar. An efficient method of transporting nanomaterials will help solve this problem.

Further, the present invention relates to a process for the production of concrete or mortar, comprising:
(a) providing a cement;
(b) providing an aggregate;
(c) providing a nanomaterial, wherein providing the nanomaterial comprises;
   (i) providing a container as described herein;
   (ii) providing a solvent;
   (iii) adding the solvent into the cavity of the container through the valve, and
   (iv) dispersing the nanomaterial in the solvent to form a diluted composition;
(d) removing the diluted composition from the container, and
(e) mixing the cement, the aggregate and the diluted composition to produce concrete or mortar.

Preferably the aggregate comprises sand when mortar is produced.

Preferably the aggregate comprises gravel or a secondary aggregate when concrete is produced. The aggregate may further comprise sand.

Preferably the diluted composition is removed from a container via a tube connected to the valve. This is a simple and safe way to remove the diluted composition. Further the tube can be used to supply the diluted composition to be mixed with the cement and the aggregate.

Preferably, the diluted composition is removed from the container using a pump. This enables the fast, efficient and accurate use of the diluted composition, or just a proportion of it. It also enhances the safety of handling the composition as it reduces the need for human intervention.

Preferably, the cement is a hydraulic cement. By using a hydraulic cement, the water required to set the cement can also be first used to dilute the composition in the container. Further, when using a hydraulic cement, the water provides an ideal medium for mixing through the composition to achieve thorough distribution throughout the concrete or mortar.

Preferably, the cement is Portland cement. Portland cement is typically used in the production of concrete or mortar.

Preferably the process comprises the further features described herein.

Further, the present invention relates to a system for use in the production of a colloidal suspension of a nanomaterial, comprising;
(A) a container as described herein;
(B) a solvent supply;
(C) a tube connecting the valve of the container to the solvent supply, and
(D) a mixer.

Preferably the mixer in an ultrasonic mixer. Preferably the ultrasonic mixer has a frequency in the range of about 1 kHz to about 30 kHz, preferably about 2 kHz to about 20 kHz. Such frequencies are suitable for mixing the composition with the solvent.

Preferably the ultrasonic mixer has an amplitude in the range of about 10 μm to about 30 μm. Such amplitudes are suitable for dispersing the nanomaterial in the solvent.

Preferably the system comprises the further features described herein.

### DETAILED DESCRIPTION OF THE DRAWINGS

Example embodiments of the present invention will now be described with reference to the accompanying figures.

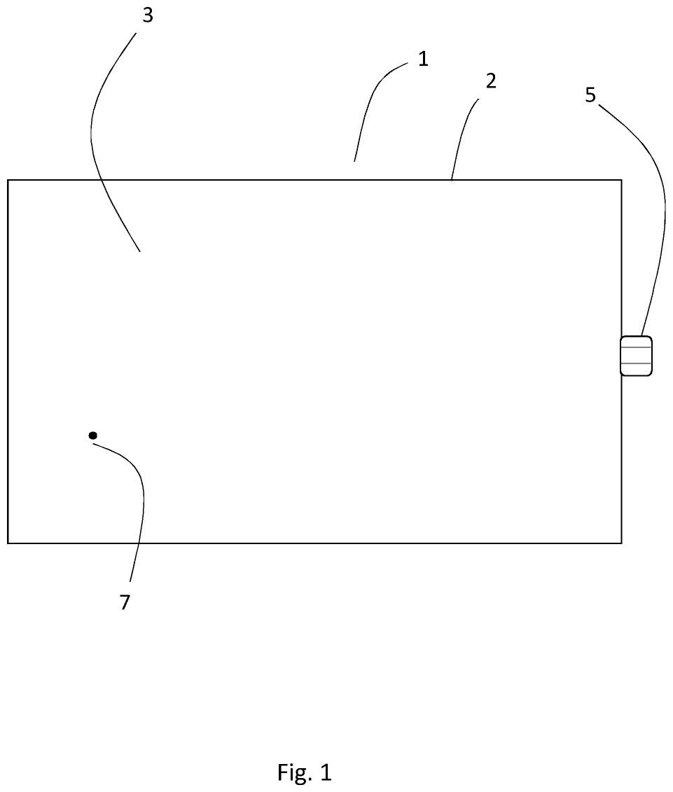

FIG. 1 shows a top view of a container 1. The container 1 comprises a wall 2 defining a cavity 3. A valve 5 allows access to the cavity 3. A nanomaterial 7 is within the cavity 3.

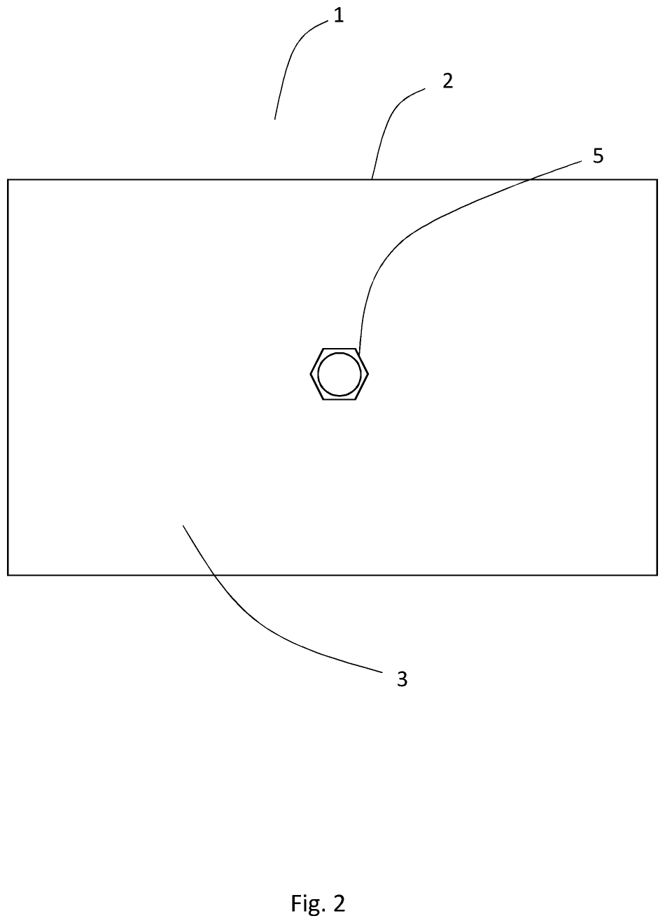

FIG. 2 shows a side view of a container 1. The container 1 comprises a wall 2 defining a cavity 3. A valve 5 allows access to the cavity 3. The cavity 3 is shown at maximum volume and contains the diluted composition.

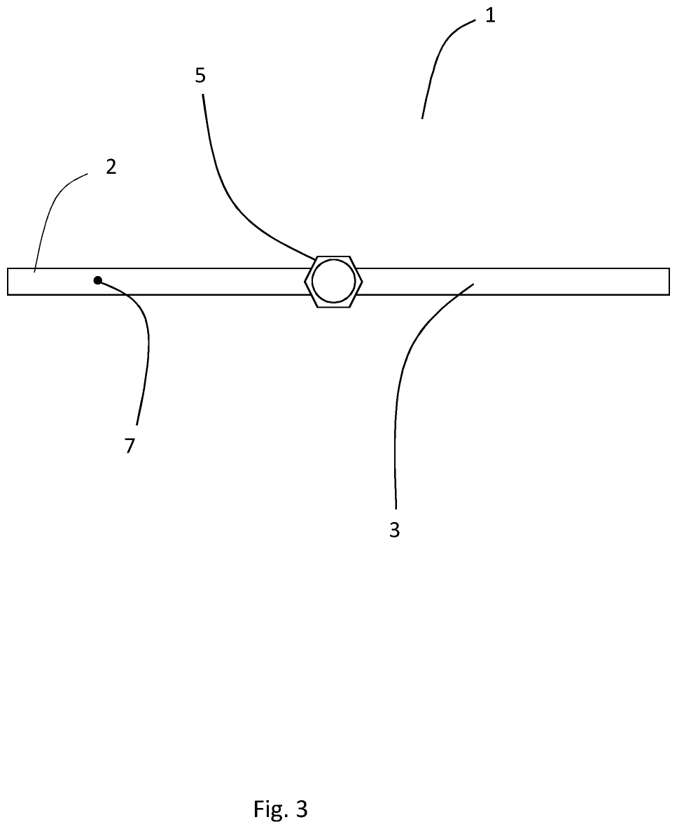

FIG. 3 shows a side view of a container 1. The container 1 comprises a wall 2 defining a cavity 3. A valve 5 allows access to the cavity 3. The nanomaterial 7 is within the cavity 3. The cavity 3 is shown prior to the addition of the solvent and as such the cross-sectional area of the container is much smaller than the cross section shown in FIG. 2.

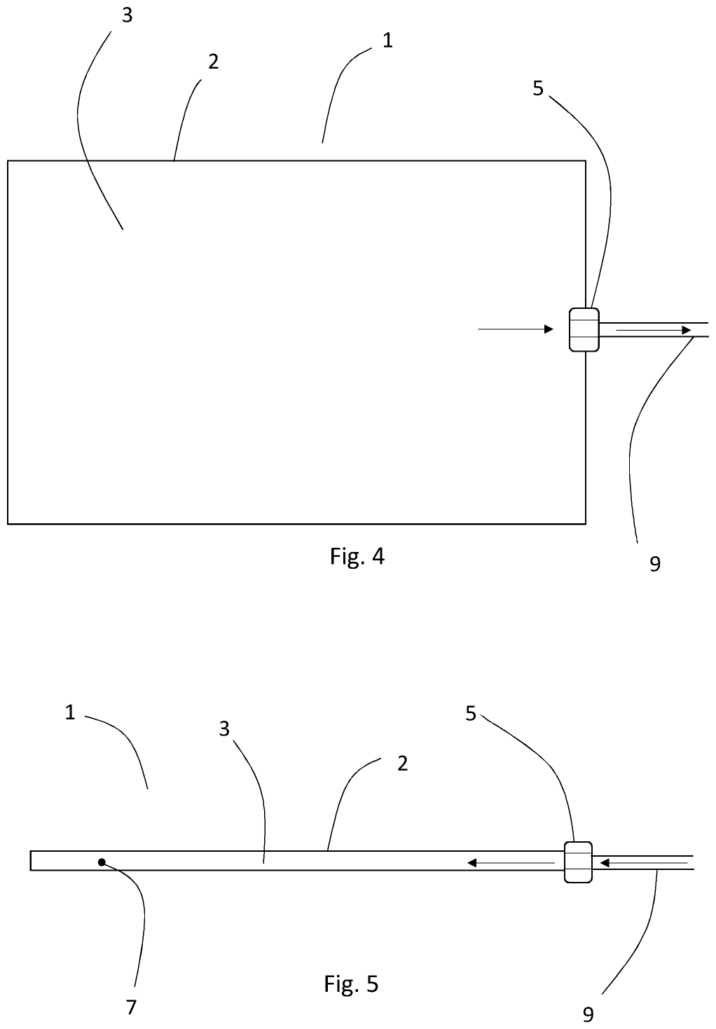

FIG. 4 shows a top view of a container 1. The container 1 comprises a wall 2 defining a cavity 3. A valve 5 allows access to the cavity 3. A tube 9 is engaged with the valve 5. The cavity 3 contains the diluted composition and the diluted composition is removed from the cavity via the valve 5 and then flows though the tube 9 for further use.

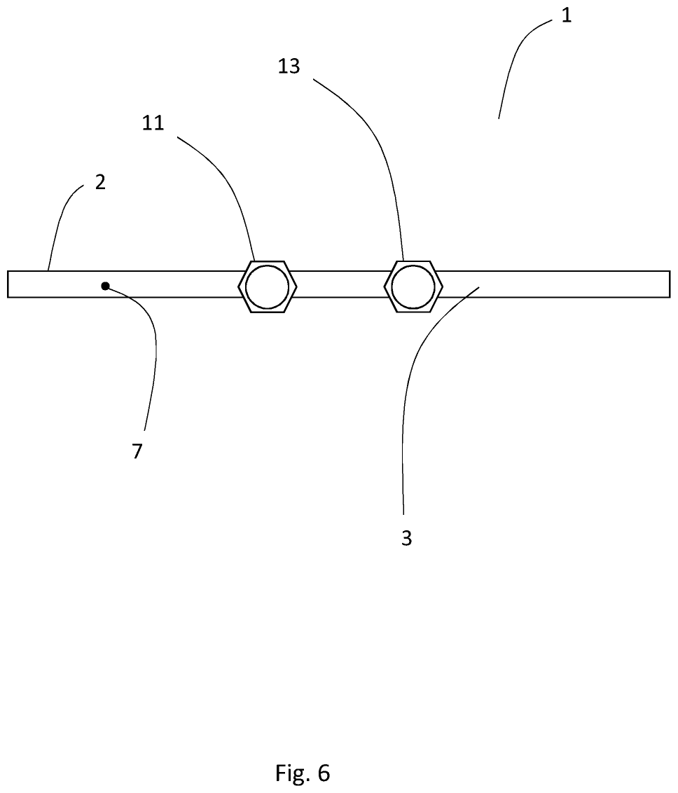

FIG. 5 shows a side view of a container 1. The container 1 comprises a wall 2 defining a cavity 3. A valve 5 allows access to the cavity 3. The nanomaterial 7 is within the cavity 3. A tube 9 is engaged with the valve 5. A solvent is introduced into the cavity 3 via the tube 9 and the valve 5. As the solvent is introduced to the cavity 3, the wall 2 will bias out to increase the volume of the cavity, up to the maximum volume of the cavity. It will be appreciated that it is not necessary to fill the cavity to the maximum volume and less solvent can be added for a given use.

FIG. 6 shows a container 1 comprising a wall 2 defining a cavity 3. The nanomaterial 7 is within the cavity 3. An inlet valve 13 allows solvent to enter the cavity 3 to make a diluted composition. The outlet valve 11 allows the diluted composition to exit the container. The cavity 3 is shown prior to the addition of the solvent and the volume of the cavity 3 will increase as the solvent is added.

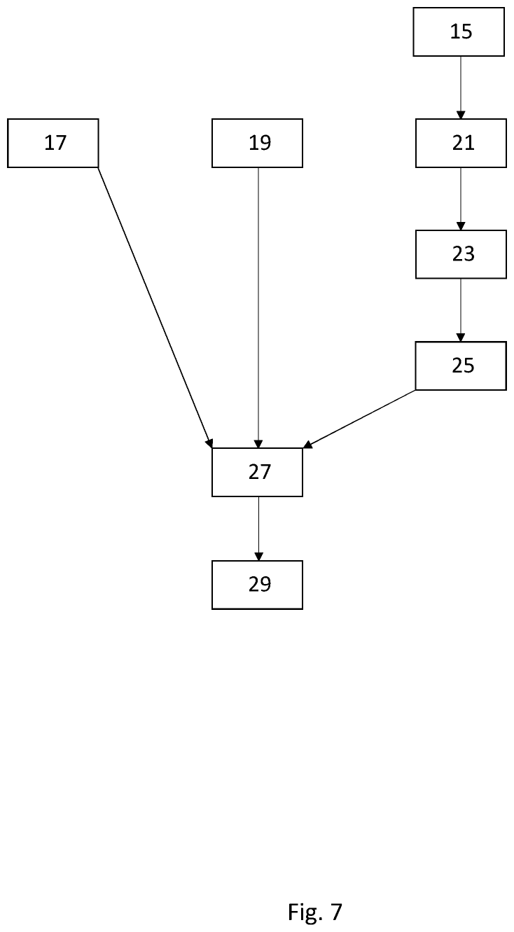

FIG. 7 shows a flow chart of a process for the production of concrete or mortar. The process comprises providing a container 21 comprising a composition, adding a solvent 15 into the cavity of the container. The nanomaterial is then dispersed in the solvent, preferably by treating the container ted with ultrasound 23 to form a dilute composition 25. The diluted composition 25 is then removed from the container. The dilute composition 25, cement 17 and aggregate 19 are then mixed 27 to form concrete or mortar 29.

It will be appreciated that the shape of the container and the position of the valve(s) can vary and are not necessarily as shown in the figures. Furthermore, it will be appreciated that the nanomaterial may be in any position within the container.

In the context of this specification it will be understood that “cavity” refers to the total interior volume defined by the walls of the container. This is taken to include the volume of any solids, liquids or gases that may be present within the walls of the container.

In the context of this specification “a container” means “a container containing a composition”.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein and vice versa.

Within this specification, the term “about” means plus or minus 20%, more preferably plus or minus 10%, even more preferably plus or minus 5%, most preferably plus or minus 2%.

It will be appreciated that reference to “a” includes reference to “a plurality”.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications are covered by the appended claims.

1. A container, wherein the container comprises a wall and a valve,
wherein the wall defines an interior cavity,
wherein the cavity has an adjustable volume,
wherein the cavity contains a composition,
wherein the composition comprises a nanomaterial, and
wherein the volume of the composition is less than or equal to about 50 vol % of the maximum volume of the cavity.

2. The container according to claim 1, wherein the volume of the composition is in the range of about 0.001 vol % to about 50 vol % of the maximum volume of the cavity.

3. The container according to any preceding claim 1, wherein the wall of the container is flexible.

4. The container according to claim 1, wherein the valve allows access to the cavity in a first valve position and prevents access to the cavity in a second valve position.

5. The container according to claim 1, wherein the nanomaterial is present in the composition in the range of about 0.01 wt % to about 80 wt %.

6. The container according to claim 1, wherein the composition further comprises a surface modifier.

7. The container according to claim 6, wherein the surface of the nanomaterial is functionalised with the surface modifier.

8. The container according to claim 1, wherein the container is a sealed container,
wherein the container comprises a flexible wall and a valve,
wherein the wall defines an interior cavity,
wherein the cavity has an adjustable volume,
wherein the cavity contains a composition,
wherein the composition comprises a nanomaterial,
wherein the volume of the composition is less than or equal to about 1 vol % of the maximum volume of the cavity, and
wherein the maximum volume of the cavity is about 0.5 L to about 10 L.

9. A process for making a diluted composition, comprising;
(i) providing a container according to claim 1;
(ii) providing a solvent supply;
(iii) adding the solvent into the cavity of the container through the valve, and
(iv) dispersing the nanomaterial in the solvent to form a diluted composition.

10. The process according to claim 9, wherein the solvent is a polar solvent.

11. The process according to claim 9, wherein the diluted composition is a colloidal suspension of the nanomaterial.

12. Use of the container according to claim 1 in a process of producing concrete or mortar.

13. Use according to claim 12, wherein the process for producing concrete or mortar, comprises:
(a) providing a cement;
(b) providing an aggregate;
(c) providing a nanomaterial, wherein providing the nanomaterial comprises;
(i) providing a container according to claim 1;
(ii) providing a solvent;
(iii) adding the solvent into the cavity of the container through the valve; and
(iv) dispersing the nanomaterial in the solvent to form a diluted composition;
(d) removing the diluted composition from the container; and
(e) mixing the cement, the aggregate and the diluted composition to produce concrete or mortar.

14. Use according to claim 13, wherein the cement is a hydraulic cement.

15. A system for use in the production of a colloidal suspension of a nanomaterial, comprising;
(A) a container according to claim 1;
(B) a solvent supply;
(C) a tube connecting the valve of the container to the solvent supply, and
(D) a mixer.

16. The container according to claim 1, wherein the volume of the cavity is adjusted/adjustable by moving the wall.
